(19) United States
(12) Patent Application Publication
(10) Pub. No.: US 2026/0152619 A1
(43) Pub. Date: Jun. 4, 2026

(54) CARBON-BASED NANOMATERIALS AS DOPANTS FOR NOVEL MULTIFUNCTIONAL COMPOSITES

(71) Applicant: The Trustees of Boston College, Chestnut Hill, MA (US)

(72) Inventors: Michael Giersig, Kleinmachnow (DE); Krzysztof Kempa, Chestnut Hill, MA (US); Jacek Michalczuk, Berlin (DE); Slawomir Wilczewski, Bydgoszcz (PL)

(73) Assignee: The Trustees of Boston College, Chestnut Hill, MA (US)

(21) Appl. No.: 19/114,816

(22) PCT Filed: Sep. 26, 2023
(86) PCT No.: PCT/US2023/075092

§ 371 Date: Mar. 25, 2025

Related U.S. Application Data
(60) Provisional application No. 63/377,060, filed on Sep. 26, 2022.

(51) Int. Cl. C08K 3/04; C01B 32/16; C01B 32/168; C01B 32/184; C01B 32/194; C08G 59/22

(52) U.S. Cl. CPC C08K 3/041; C01B 32/16; C01B 32/168; C01B 32/184; C01B 32/194; C08G 59/22; C01P 2004/133; C01P 2004/64; C01P 2006/16; C01P 2006/42

(57) ABSTRACT

A carbon-based nanomaterial resin composite comprising epoxy resin doped with carbon-based nanomaterial fillers and the method of making is disclosed. The composite includes doping epoxy resin with surface-modified carbon-based nanomaterials including graphene and carbon nanotubes that improve the mechanical properties such as strength and Young's modulus of the doped resin. Surface modification includes oxidizing the surface of the carbon-based nanomaterials, coating the surface with polymers, and distributing magnetic nanoparticles on the surface of the carbon-based nanomaterials. In another aspect, an external magnetic field may be applied to prevent agglomeration of and directionally align the carbon-based nanomaterials within the resin matrix promoting covalent and non-covalent interactions thereby mechanically and thermally stabilizing the resin composite.

### CROSS-REFERENCE TO RELATED APPLICATIONS

This patent document is the U.S. national phase of international patent application number PCT/US23/75092, filed Sep. 26, 2023, which claims priority to U.S. provisional patent application No. 63/377,060, filed Sep. 26, 2022, the disclosures of which are fully incorporated into this document by reference.

### FIELD

The present technology is generally related to carbon-based nanomaterials, and more particularly, resin composites based on carbon-based nanomaterial dopants or fillers.

### BACKGROUND

Reinforcement of resin composites by fillers and dopant materials is being increasingly used in a wide range of areas to improve the intrinsic mechanical properties of the composite. Fillers such as glass and carbon fibers, oxides such as silica (silicon dioxide) and alumina (aluminum oxide), as well as metallic powders have been utilized in order to improve the mechanical, thermal, and electrical properties of the resin composite. However, these macro-scale fillers, which require a high loading percentage to achieve desired property enhancement, reduce the intrinsic properties of the host resin, increase the resin weight, and are costly due to lack of scalability and complex processing, which requires manual orienting or aligning of the filler materials. Consequently, nanoscale materials are promising replacements as they require a significantly lower loading percentage to achieve similar or greater property enhancements.

Despite the wide investigation of nanomaterials such as metallic and/or magnetic nanoparticles, carbon nanotubes, and graphene, one of the main problems lies in the linking of said nanomaterials with the host material, such as resin matrix, whose physical and chemical properties are affected by quantum size effects of the nanomaterials. Thus, obtaining the new class of composite materials doped with nanomaterials requires a new approach, considering their specificity. In contrast to conventional resins with lower mechanical resistance, carbon-based nanomaterials are ideal for doping due to their exceptional properties stemming from their nanoscale structures.

For example, multi-walled carbon nanotubes (MWCNTs) are among the best-studied carbon nanomaterials and are very promising as a filler material due to their excellent mechanical properties such as high strength and elasticity, thermal properties, electrical properties, high-aspect ratio, as well as facile surface modification with functional groups, polymers, and other nanomaterials. Another promising carbon-based nanomaterial is graphene (GN), a two-dimensional sheet of carbon atoms arranged in an infinite honeycomb lattice. The material properties of GN often exceed those of any other material for example, electron mobility, ballistic transport, high-strength, and elasticity, as well as facile covalent and non-covalent surface modification.

Progress in the development of methods to effectively dope host resins with carbon-based nanomaterials that impart these excellent properties, based on the modification of the carbon-based fillers, remains very slow. Currently, some of the challenges that exist affecting the development of carbon-based nanomaterial resin composites viable for use in real-world applications include understanding the fundamental interactions at the interface of carbon-based nanomaterial and microscale resin, namely where attempts have been made to combine the carbon-based nanomaterials inducing quantum effects to the micromaterials with solid-state properties. The difficulties that arise and how they are solved are of particular interest not only for basic research but especially for engineering sciences.

It would thus be desirable for a method to produce carbon-based nanomaterial resin composite that transfers functional properties of the modified and unmodified carbon-based nanomaterials to the host resin matrix that offers many property advantages including enhanced material strength, elasticity, thermal properties, as well as tunable response to introduced magnetic field.

### SUMMARY

The technology of this disclosure generally relates to carbon-based nanomaterial resin composite comprising a host resin doped with a carbon-based nanomaterial filler, wherein the filler comprises: a carbon-based nanomaterial; and magnetic nanoparticles attached to the carbon-based nanomaterials In various embodiments, the host resin may comprise a resin selected from the group consisting of epoxy-based resin, polyester resin, vinyl ester resin, polyurethane resin, phenolic resin, polyimide resin, silicone resin, and acrylic resin, or a combination thereof. In various embodiments, the carbon-based nanomaterials may comprise single-walled carbon nanotubes, multi-walled carbon nanotubes, graphene, or a combination thereof. In other embodiments, the carbon-based nanomaterials may comprise magnetic nanoparticles present at nanotube ends and/or confined within the inner space of the single-walled carbon nanotubes or multi-walled carbon nanotubes.

In various embodiments, the carbon-based nanomaterials may be oxidized. In various embodiments, the carbon-based nanomaterials may comprise one or more substituents selected from the group consisting of silane, hydroxyl, carboxylic acid, amine, and any combination thereof. In various embodiments, magnetic nanoparticles may be present in the composite and comprise a metal, an alloy, a metal oxide, or a combination thereof. In various embodiments, the magnetic nanoparticles may comprise nickel, iron, cobalt, alloys thereof, oxides thereof, or a combination thereof. In various embodiments, the diameter of the magnetic nanoparticles may be from about 3 nm to about 100 nm. In various embodiments, the carbon-based nanomaterial resin composite may have tensile strength of more than 0.35 GPa and a Young's Modulus of more than 5.50 GPa. In various embodiments, the carbon-based nanomaterial filler may comprise between about 0.1 wt. % and about 5 wt. % of the total weight of the host resin. In various embodiments, the magnetic nanoparticles and carbon-based nanomaterials may be mixed in a mass ratio of about 1:100 to about 4:100.

In another aspect an article comprising the carbon-based nanomaterial resin composite of the present document is disclosed. In various embodiments, the article comprising the carbon-based nanomaterial resin composite may comprise an automotive part, electromagnetic interference and radiofrequency shielding, antistatic coating, flexible and printable electronics, batteries, supercapacitors, heat sinks, and water filters.

In another aspect, a method for synthesizing a carbon-based nanomaterial resin composite of above is disclosed. The method includes: (a) growing carbon-based nanomaterials, wherein magnetic nanoparticles are attached to the carbon-based nanomaterials; (b) optionally oxidizing surface of the carbon-based nanomaterials; (c) optionally coating surface of the carbon-based nanomaterials; and (d) introducing carbon-based nanomaterials of step (a), (b), or (c) to a host resin. In various embodiments, the step (c) may further comprise coating the carbon-based nanomaterials with one or more substituents selected from the group consisting of silane, hydroxyl, carboxylic acid, amine, and any combination thereof.

In various embodiments, the method may further comprise before step (d), optionally attaching additional magnetic nanoparticles on the carbon-based nanomaterials of steps (a), (b), or (c). In various embodiments, the method may comprise introducing about 0.1 wt. % and about 5 wt. % of carbon-based nanomaterials in steps (a), (b), or (c) to the host resin, based on the total weight of the host resin.

In various embodiments, the method may further comprise uniformly dispersing the carbon-based nanomaterials in the host resin, the method comprising: placing the carbon-based nanomaterial resin composite in an alternating magnetic field, wherein the alternating magnetic field results in heating of the magnetic nanoparticles and uniform dispersion of the carbon-based nanomaterials in the host resin. In further embodiments, the method may comprise aligning the carbon-based nanomaterials in the host resin, the method comprising: switching the alternating magnetic field to a constant magnetic field, wherein the constant magnetic field results in an alignment of the carbon-based nanomaterials along direction of the constant magnetic field.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A shows an example configuration of randomly distributed carbon-based nanomaterial in a resin polymer chain.

FIG. 1B shows an example configuration of de-clustered and directionally oriented carbon-based nanomaterial coated with magnetic nanoparticles in a resin polymer chain.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another and is not intended to require a sequential order unless specifically stated. The terms “approximately” and “about” when used in connection with a numeric value, are intended to include values that are close to, but not exactly, the number. For example, in some embodiments, the terms “approximately” and “about” include values that are within +/−5 percent of the value, and in some embodiments values that are within +/−10 percent of the value.

In this document, the term “coating”, when referring to surface modification of carbon-based nanomaterials, means that the material to be coated on the surface may or may not fully enclose the carbon-based nanomaterial. For example, “coating” of magnetic nanoparticles on MWCNTs may be one or more nanoparticles bonded, or adsorbed on the MWCNT surface, and may not fully enclose the surface of the MWCNT. Similarly, when referring to “silane-coated” MWCNTs or GNs, silane groups may not fully enclose the surface of the carbon-based nanomaterials, and may simply be extending outward from the surface of the carbon-based nanomaterials.

In this document, the term “attaching”, when referring to modification of carbon-based nanomaterials with magnetic nanoparticles means magnetic nanoparticles are present on the surface, in the inner matrix, such as inner diameter of single-walled and multi-walled carbon nanotubes or between graphene layers. Additionally, the term “attaching” of magnetic nanoparticles means that magnetic nanoparticles may be connected to the carbon-based nanomaterials by both covalent and non-covalent interactions.

The present disclosure is directed to a carbon-based nanomaterial resin composite comprising a host resin doped with a filer comprising modified carbon-based nanomaterials and an article manufactured therefrom. The present disclosure is also directed to the method of synthesizing the carbon-based nanomaterial resin composite. Further, the present disclosure is directed to a method of aligning the carbon-based nanomaterials doped within the host resin by applying an external magnetic field and inductive heating.

The carbon-based nanomaterial based resin composite may include carbon-based nanomaterials comprising single-walled carbon nanotubes (SWCNTs), multi-walled carbon nanotubes (MWCNTs), graphene nanoflakes, graphene platelets, single-layer graphene, and few-layer graphene in a pure and uncontaminated form. The fabrication of carbon-based nanomaterials of the disclosure is designed to be compatible with conventional synthesis and fabrication methods. The carbon-based nanomaterial of the present disclosure may be synthesized by methods including chemical vapor deposition (CVD), and plasma-enhanced chemical vapor deposition (PECVD) based on the vapor-liquid-solid (VLS) mechanism. In the VLS mechanism, catalytic nanoparticles on a substrate serve as nucleation sites upon growth initiation, a carrier gas and a gaseous carbon source are introduced. The carbon source gas is first decomposed, and then, products diffuse onto and into the catalyst nanoparticles and are present as solid carbon nanotube formation upon saturation. In this method, high-purity MWCNTs may be produced.

The diameter of the CNTs depends on the nanoparticle size located at the top (tip-growth) or the bottom (bottom-growth) of the CNTs, determined by the particle-substrate adhesion. For instance, in some embodiments, at an elevated temperature from about 600° C. and about 900° C., nano-sized liquid nickel droplets are formed from a thin Ni film, which acts as a liquid catalyst in the formation of solid CNTs products from carbon species of from decomposed hydrocarbon such as methane or ethane. In various embodiments, the catalyst used to synthesize CNTs may comprise nanoparticles of nickel, iron, cobalt, alloys thereof, oxides thereof, and combinations thereof. In various embodiments, the magnetic nanoparticles that were used as the growth catalyst may be present at the nanotube end and/or confined within the inner space of the single-walled carbon nanotubes or multi-walled carbon nanotubes.

In some embodiments, directional MWCNT growth is achieved by the directional bombardment of positive species onto the sample surface in the direct current (DC) plasma during the growth process, resulting in vertically aligned MWCNT growth along the electric field lines. The high-purity MWCNTs fabricated from this method typically are about 1 and 5 m in length and about 40 and 150 nm in diameter.

In another method, single- or multi-layer graphene (GN) may be fabricated by the CVD method using copper (Cu) foil as the growth substrate and decomposing methane as the gaseous carbon source for nucleation and expansion of carbon atoms on the Cu substrate. Copper is considered to be an optimal substrate for graphene growth due to the low solubility of carbon, high catalytic activity for promoting the decomposition of hydrocarbons into carbon atoms to nucleate on the copper surface, and lattice matching with graphene, which reduces the formation of defects during the growth resulting in a greater growth area with fewer defects.

Unmodified carbon-based nanomaterials including GN and MWCNTs may be then modified on the surface both covalently and noncovalently. The covalent modification involves covalently functionalizing the surface or the edges of the carbon-based nanomaterials at the π-conjugated backbone and defect sites such as interstitial sites, substitution sites, and vacancies. In some embodiments, defect sites can be engineered by chemically treating with acids to produce oxidized carbon-based nanomaterials. Oxidized carbon-based nanomaterials allow for greater reactivity and modification on the surface due to the presence of highly reactive oxygen, or nitrogen-containing functional groups such as but not limited to hydroxyl (—OH), epoxide (—O—), carbonyl (—CO), carboxyl (—COOH), or amino (NH₂) groups.

Noncovalent modification of carbon-based nanomaterials involves surface adsorption or wrapping of various functional molecules on the external surface such as resin polymer chains stabilized by van der Waals interactions, π-π interactions, or electrostatic interaction between metal-based nanoparticles and carbon-based nanomaterials. To facilitate electrostatic interaction between carbon-based nanomaterials surface and metal-based nanoparticles, carbon-based nanomaterials are modified using silane coupling agent such (3-aminopropyl) trimethoxysilane. In this method, carbon-based nanomaterial is first coated with a polyelectrolyte solution of allylamine hydrochloride (PAH) and modified with tetraethoxysilane (THEOS) to produce silane-coated carbon-based nanomaterials. This surface can further be coated with silica which further protects the adsorbed metal-based nanoparticles from oxidation and provides an active surface for further modification.

Using the unmodified or bare and surface-modified carbon-based nanomaterials of this disclosure, a carbon-based nanomaterial resin composite comprising a host resin doped with carbon-based nanomaterial filler is fabricated from the disclosed method. In various embodiments, the host resin may comprise epoxy-based resin, polyester resin, vinyl ester resin, polyurethane resin, phenolic resin, polyimide resin, silicone resin, and acrylic resin, or a combination thereof. In various embodiments, the epoxy resin may be bisphenol-A based, bisphenol-F based, or vinyl ester-based. In various embodiments, any resin that is capable of cross-linking under ultraviolet (UV) light or heat treatment. In various embodiments, the carbon-based nanomaterial filler may comprise unmodified or unmodified graphene, SWCNTs, MWCNTs, or combinations thereof.

In various embodiments, the carbon-based nanomaterial may be modified by the methods disclosed above. In some embodiments, the carbon-based nanomaterial may be oxidized by using concentrated acids such as sulfuric acid (H₂SO₄), nitric acid (HNO₃), or a mixture of the two. In various embodiments, H₂SO₄ and HNO₃ may be mixed in a volume ratio from about 5:1 and about 2:1. In certain embodiments, about 1 g to about 1.5 g of carbon-based nanomaterial may be incorporated with about 500 mL of acid or an acid mixture. After adding the carbon-based nanomaterials to the acid, the solution is agitated for about 30 minutes, sonicated for about 30 minutes, and then left to stabilize for about 10 to 15 hours, upon which the oxidized carbon-based material is recovered and dried.

In other embodiments, both unmodified and oxidized carbon-based nanomaterial may be modified by coating the surface with silanes, hydroxyl, carboxylic acid, amine, and any combination thereof. In various embodiments, a solution of about 3 to about 5 wt. % of allylamine hydrochloride (PAH) in about 0.5 M sodium chloride (NaCl) solution is mixed with unmodified or oxidized carbon-based nanomaterials. In various embodiments, between about 2.0 and about 2.5 g of unmodified or oxidized carbon-based nanomaterial may be incorporated with about 500 mL of PAH-NaCl solution. After adding the carbon-based nanomaterials to the acid, the solution is sonicated for 4 hours, agitated for about 1 hour, and then left to stabilize for about 10 to about 15 hours, upon which the PAH-coated carbon-based material is recovered. Next, a solution of 98% THEOS, ethanol, and distilled water in a mass ratio of about 2:1:4 is added to the PAH-coated carbon-based nanomaterial and centrifuged for about 1 hour and left to stabilize for 40 hours and recovered producing (1) silane-coated, unmodified-carbon-based nanomaterial, and (2) silane-coated, oxidized-carbon nanomaterial.

In various embodiments, carbon-based nanomaterials modified by oxidation, coating, or both result in improved mechanical and thermal properties of the composite compared to the base, undoped, resin system. In various embodiments, about 43% improvement in Young's or elastic modulus, and about 68% enhancement in strength may be achieved depending on the type of the carbon-based nanomaterial modification and the quantity of the modified carbon-based nanomaterial incorporated in the resin.

In various embodiments, dried (1) unmodified carbon-based nanomaterials, (2) oxidized carbon-based nanomaterials, (3) coated, unmodified carbon-based nanomaterials, and (4) coated, oxidized carbon-based nanomaterial is mixed with the host resin in amounts of about 0.1 to about 5 wt. %, based on the total weight of the host resin. Nonlimiting examples of the amount of carbon-based nanomaterials mixed with the host resin include about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, based on the total weight of the host resin, and any range between any two of the aforementioned values. In various embodiments, the host resin may comprise epoxy-based resin, polyester resin, vinyl ester resin, polyurethane resin, phenolic resin, polyimide resin, silicone resin, and acrylic resin, or a combination thereof. In various embodiments, the epoxy resin may be bisphenol-A based, bisphenol-F based, or vinyl ester-based. In various embodiments, any resin that is capable of cross-linking under ultraviolet (UV) light or heat treatment.

In various embodiments, after mixing the carbon-based nanomaterials with the host resin, a hardener may be added and stirred for about 2 minutes to activate the resin. The resin is then degassed, left to stabilize for 24 hours, and subsequently heat treated at a temperature of about 120° C. for about 96 hours to cure the carbon-based nanomaterial resin composite.

In various embodiments, prior to hardening and curing of the host resin, the carbon-based nanomaterials may be further modified with magnetic nanoparticles on the surface. In various embodiments, the diameter of the magnetic nanoparticles may be modified depending on the magnetic properties required for specific applications. In various embodiments, magnetic nanoparticles may be added to the catalyst or precursor medium during carbon-based nanomaterial synthesis to attach the magnetic nanoparticles to the carbon-based nanomaterials. In other embodiments, magnetic nanoparticles may be attached to the carbon-based nanomaterials after the synthesis and preceding modifications including oxidation and coating on the surface of the carbon-based nanomaterials.

In various embodiments, the magnetic nanoparticles may comprise superparamagnetic properties or ferromagnetic properties depending on the diameter of the magnetic nanoparticles. In various embodiments, the diameter of the magnetic nanoparticles may be between about 3 nm and about 100 nm, about 15 nm to about 85 nm, about 30 nm and about 70 nm, or about 45 nm and about 55 nm. In other embodiments, the diameter of the magnetic nanoparticles may be between about 3 nm and about 20 nm, about 20 nm to about 40 nm, about 40 nm and about 60 nm, about 60 nm and about 80 nm, or about 80 nm to about 100 nm. Nonlimiting examples of the diameter of the magnetic nanoparticles include about 3 nm, about 5 nm, about 10 nm, about 15 nm, about 20 nm, about 25 nm, about 30 nm, about 40 nm, about 50 nm, about 60 nm, about 70 nm, about 80 nm, about 90 nm, about 100 nm, and any range between any two of the aforementioned values.

In various embodiments, the diameter of the magnetic nanoparticles exhibiting superparamagnetic properties may be between about 3 nm and about 12 nm, about 5 nm and about 10 nm, or about 7 nm. In other embodiments, the diameter of magnetic nanoparticles exhibiting ferromagnetic properties may be between about 12 nm to about 100 nm, about 15 nm to about 85 nm, about 30 nm and about 70 nm, or about 45 nm and about 55 nm.

In various embodiments, the magnetic nanoparticles may be metallic including Ni, Fe, Co, alloys thereof, or combinations thereof. In other embodiments, the magnetic nanoparticles may be oxides of the metals including but not limited to FeO, Fe₂O₃, Fe₃O₄, Co₃O₄, NiO, Ni₂O₃, Ni₃O₄. In various embodiments, the magnetic nanoparticles may be doped oxide structures comprising up to about 50% of the dopant such as iron-doped cobalt oxide, cobalt-doped iron oxide, nickel-doped iron oxide, nickel-doped cobalt oxide, iron-doped nickel oxide, or cobalt-doped nickel oxide. In various embodiments, the loading of magnetic nanoparticles improves the thermal properties of the carbon-based nanomaterial resin composite due to increased dispersion and uniform distribution of heat in the material. In various embodiments, magnetic nanoparticles may be loaded on the carbon-based nanomaterials in a mass ratio of about 1:100 and about 20:100 to prevent agglomeration or clumping between the magnetic nanoparticles. Nonlimiting examples of the ratio between the magnetic nanoparticles and the carbon-based nanomaterials include about 1:100, about 1:150, about 1:200, about 2:100, about 3:200, about 4:100, about 5:100, about 8:100, about 10:100, about 15:100, about 20:100, and any range between any two of the aforementioned values.

In various embodiments, metals such as cobalt, iron, or nickel, that are used as precursors to grow CNTs may be present at nanotube ends and/or confined in the space CNTs. In various embodiments, the diameter of the metal structure may be between about 3 nm and about 500 nm, 25 nm and 400 nm, 50 nm and 300 nm, 75 nm and about 200 nm, or 100 nm and about 150 nm. Nonlimiting examples of the diameter of the metal structure include about 3 nm, about 10 nm, about 25 nm, about 50 nm, about 75 nm, about 100 nm, about 150 nm, about 200 nm, about 250 nm, about 300 nm, about 350 nm, about 400 nm, about 450 nm, about 500 nm, and any range between any two of the aforementioned values.

The incorporation of magnetic nanoparticles within the matrix of the carbon-nanomaterial-based resin composite, e.g., the surface of the carbon-based nanomaterial, allows for the induction of magnetic response by applying an external magnetic field to the carbon nanomaterial-based resin composite. Magnetic nanoparticles interact with an alternating magnetic field (AMF) to generate a controllable temperature that may lead to cross-linking of the polymer chains within the resin matrix. Accordingly, the applied external magnetic field induces uniform dispersion of the aggregates by de-clustering the carbon-based nanomaterial aggregates within the resin matrix.

The homogeneous dispersion of carbon-based nanomaterials within the host resin results in uniform, volumetric heating of the resin by the Neel effect. As magnetic nanoparticles on the surface of the carbon-based nanomaterials are exposed to an alternative magnetic field, the magnetic moment in the magnetic nanoparticles attempts to synchronize with the oscillation in the AMF. This continuous change in the oscillating magnetic field results in a rapid flip in the magnetic moment in the nanoparticle which dissipates in the form of heat within the nanoparticle. This released heat, which is highly localized to the host resin surrounding the nanoparticles, results in heat-induced cross-linking of the resin polymers which further improves the stability of the composite and improves the mechanical properties. In various embodiments, the frequency of the alternating magnetic field is related to the temperature of the released heat from the nanoparticle due to continuous flips in the magnetic moment. In various embodiments, alternating magnetic field frequency may be about 100 to about 1000 kHz. Nonlimiting examples of alternating magnetic field frequency include about 100 kHz, 200 kHz, 300 kHz, 400 kHz, 500 kHz, 600 kHz, 700 kHz, 800 kHz, 900 kHz, 1000 kHz, and any range between any two of the aforementioned values.

In various embodiments, under an alternating magnetic field, the magnetic nanoparticles may be heated from about 25° C. to about 60° C., about 30° C. to about 55° C., about 35° C. to about 50° C., or about 40° C. to about 45° C. Nonlimiting examples of magnetic nanoparticle temperature under alternating magnetic field include about 25° C., about 30° C., about 40° C., about 50° C., about 60° C. and any range between any two of the aforementioned values.

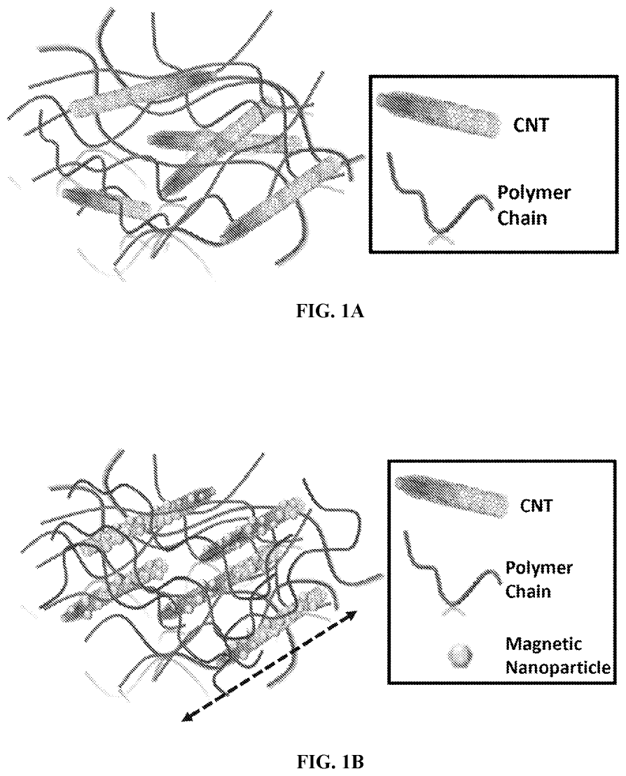

In other embodiments, a constant magnetic field, i.e., a magnetic field oriented in a single direction may be applied to orient the magnetic nanoparticle-coated carbon-based nanomaterials along the direction of the external magnetic field. In this case, hydrogen bonds between the surface of unmodified, oxidized, or silane, amino, or carboxyl-modified carbon-based nanomaterials and the host resin, π-π interactions between the carbon-based nanomaterials and the aromatic rings in the resin, van der Waals interaction, and the electrostatic interactions further stabilize the composite. Furthermore, for oxidized carbon-based nanomaterials, covalent interaction, e.g., an amide bond between the oxygen groups of the CBNM and nitrogen-containing polyelectrolytes such as allylamine hydrochloride (PAH), may be present. This interaction provides electrostatic interaction between the PAH-coated CBNM and adsorbed magnetic nanoparticles to further stabilize the resin composite, resulting in additional enhancement of mechanical, electrical, thermal, and magnetic properties. In various embodiments, nitrogen-containing polyelectrolyte may include polyethyleneimine, polydiallyl-dimethylammonium chloride, poly(allylamine-co-maleic acid), polyvinylamine, poly(vinyl amin-co-vinlyl acetate), poly(allylamine-co-2-methyl-2-oxazoline). As shown in FIGS. 1A and 1, such a combination of magnetic field-induced de-clustering/uniform dispersion and alignment of the carbon-based nanomaterials result in covalent cross-linking in the resin matrix polymers as well as the emergence of orientation-directed non-covalent interactions further stabilizing the carbon-nanomaterial based resin composite.

The nanocomposite disclosed herein exhibits excellent mechanical properties including tensile strength and Young's Modulus. In some embodiments, the tensile strength of the nanocomposite is about 0.20, about 0.22, about 0.24, about 0.26, about 0.28, about 0.30, about 0.32, about 0.34, about 0.36, about 0.36, about 0.38, or about 0.49 GPa. In some embodiments, the strength of the nanocomposite is a more than 0.22, more than 0.24, more than 0.26, more than 0.28, more than 0.30, more than 0.32, more than 0.34, more than 0.36, more than 0.38, more than 0.40 GPa.

In some embodiments, the Young's Modulus of the nanocomposite is about 3.60, about 3.80, about 4.00, about 4.20, about 4.40, about 4.60, about 4.80, about 5.00, about 5.20, about 5.40, about 5.60, about 5.80, about 6.00, or about 6.20 GPa. In some embodiments, the Young's Modulus of the nanocomposite is more than 3.60, more than 3.80, more than 4.00, more than 4.20, more than 4.40, more than 4.60, more than 4.80, more than 5.00, more than 5.20, more than 5.40, more than 5.60, more than 5.80, more than 6.00 or more than 6.20 GPa.

The features and advantages of the present disclosure are more fully shown by the following examples which are provided for purposes of illustration and are not to be construed as limiting the invention in any way.

### EXAMPLES

### Example 1: Surface Modification of Carbon-Based Nanomaterials

Two different types of carbon-based nanomaterials were selected and modified to produce eight different carbon-based nanomaterial systems; (1) unmodified carbon nanotube (CNT); (2) oxidized carbon nanotube (CNT-OX); (3) silane-coated carbon nanotubes (Si-CNT); (4) silane-coated oxidized carbon nanotube (Si-CNT-OX); (5) unmodified graphene (GN); (6) oxidized graphene (GN-OX); (7) silane-coated graphene (Si-GN); and (8) silane-coated oxidized graphene (Si-GN-OX).

### Oxidation of CNT and GN:

Multi-walled CNT and GN were oxidized with a mixture of concentrated H₂SO₄ and HNO₃ acids (volume ratio 3:1). 1.5 g of multi-walled CNT, obtained from Nano Lab, and GN, obtained from XG Science, were each added separately to the 600 ml acid mixture. Next, the resulting solution was mixed for 30 min using the magnetic mixer at a speed of 500 rpm and was sonicated for 30 min at 60° C. The mixing-sonication cycle was repeated 3 times and the solution was left to homogenize for 14 hrs. The resulting oxidized CNT and GN solutions were then washed 4 times with distilled water, and vacuum filtered using 0.45 μm filter pores. The recovered CNT-OX and GN-OX were further washed in distilled water, centrifuged at 9,000 rpm for 3 min, and finally dried at a temperature of 50° C. for 96 hrs.

### Silane Modification of CNT and GN:

A 3% solution of allylamine hydrochloride (PAH) in 0.5 M solution of NaCl was prepared to 600 ml volume. The PAH-NaCl solution was divided into 4 equal portions, i.e., 150 ml. 0.7 g of CNT, CNT-OX, GN, and GN-OX were mixed in each 150 ml aliquot and sonicated for 4 hrs to evenly disperse the materials in solution. The solution was then mixed for 1 hr at 600 rpm, and left to homogenize for 15 hrs. The solution was then washed three times with distilled water and centrifuged for 3 min at 500 rpm resulting in PAH-coated CNT, CNT-OX, GN, and GN-OX.

Next, a solution of tetraethoxysilane 98% (THEOS) in a mixture of ethanol and distilled water in a 2:1:4 mass ratio was prepared and added to PAH-coated CNT, CNT-OX, GN, and GN-OX and centrifuged for 1 h at 500 rpm. The resulting mixtures were then left to homogenize for 40 hrs and centrifuged three times at 5000 rpm for 3 min. resulting precipitate washed with ethanol and dried in 60° C. for 72 hrs producing silane-coated carbon additives: Si-CNT, Si-CNT-OX, Si-GN, and Si-GN-OX.

### Example 2: Fabrication of Carbon-Based Nanomaterial Resin Composite

Unmodified CNT and GN, as well as modified Si-CNT, Si-CNT-OX, Si-GN, and Si-GN-OX, were mixed with the resin mixture (resin+hardener) using a magnetic mixer to produce 0.1, 0.5, 1, 2, and 4 wt. % (per resin mass). Commercially available Epoxy L20 and Hardener EPH 161 were obtained from R&G Faserverbundwerkstaffe GmbH. In general, after adding the carbon-based nanomaterials to the Epoxy L20, the hardener EPH 161 was added and mixed for 2 minutes. The resulting composite was then degassed in a vacuum (1 bar), poured into a silicone container, and left to harden for 24 hours. After hardening, the composite was kept under a temperature of 120° C. for 96 hrs to complete the curing process.

### Example 2: Mechanical Characteristics of Carbon-Based Nanomaterial Resin Composite

Mechanical properties, e.g., strength and Young's modulus of various carbon-based nanomaterial resin composites were measured using the nanoindentation technique and compared with a based, undoped Epoxy L20 system.

TABLE 1
Mechanical properties of CNT-based resin composites.

| Material | Strength (GPa) | Young's Modulus (GPa) |
|---|---|---|
| Epoxy L20 | 0.22 | 4.04 |
| Epoxy + 0.1% CNT | 0.21 | 3.74 |
| Epoxy + 0.5% CNT | 0.21 | 4.04 |
| Epoxy + 1% CNT | 0.24 | 4.15 |
| Epoxy + 2% CNT | 0.23 | 4.11 |
| Epoxy + 4% CNT | 0.32 | 4.93 |
| Epoxy + 0.1% CNT-OX | 0.22 | 3.79 |
| Epoxy + 0.5% CNT-OX | 0.23 | 3.84 |
| Epoxy + 1% CNT-OX | 0.23 | 4.04 |
| Epoxy + 2% CNT-OX | 0.23 | 4.51 |
| Epoxy + 4% CNT-OX | 0.32 | 4.52 |
| Epoxy + 0.1% Si-CNT | 0.27 | 4.38 |
| Epoxy + 0.5% Si-CNT | 0.27 | 4.38 |
| Epoxy + 1% Si-CNT | 0.26 | 4.25 |
| Epoxy + 2% Si-CNT | 0.27 | 4.22 |
| Epoxy + 4% Si-CNT | 0.29 | 4.61 |
| Epoxy + 0.1% Si-CNT-OX | 0.29 | 4.53 |
| Epoxy + 0.5% Si-CNT-OX | 0.27 | 4.47 |
| Epoxy + 1% Si-CNT-OX | 0.29 | 4.52 |
| Epoxy + 2% Si-CNT-OX | 0.27 | 4.48 |
| Epoxy + 4% Si-CNT-OX | 0.29 | 4.56 |

As shown in Table 1, the base Epoxy L20 exhibits a strength of 0.22 GPa and Young's modulus of 4.04 GPa. Upon doping the composite with CNT-based nanomaterials, e.g., CNT, CNT-OX, Si-CNT, and Si-CNT-OX, both strength and Young's modulus increased in all doping percentages above 1% by total weight of epoxy. The largest enhancements in both strength and Young's modulus were observed at 4% doping of CNT, CNT-OX, Si-CNT, and Si-CNT-OX compared to the base, undoped epoxy resin. The highest strength value was observed at 4% doping of oxidized CNT (Epoxy+4% CNT-OX) with over 4500 increase while the highest Young's modulus was observed at 4% doping of CNT (Epoxy+4% CNT) with over 22% increase.

TABLE 2
Mechanical properties of GN-based resin composites.

| Material | Strength (GPa) | Young's Modulus (GPa) |
|---|---|---|
| Epoxy L20 | 0.22 | 4.04 |
| Epoxy + 0.1% GN | 0.22 | 3.72 |
| Epoxy + 0.5% GN | 0.24 | 4.15 |
| Epoxy + 1% GN | 0.23 | 3.9 |
| Epoxy + 2% GN | 0.22 | 3.9 |
| Epoxy + 4% GN | 0.35 | 5.25 |
| Epoxy + 0.1% GN-OX | 0.22 | 3.8 |
| Epoxy + 0.5% GN-OX | 0.22 | 3.8 |
| Epoxy + 1% GN-OX | 0.22 | 4.25 |
| Epoxy + 2% GN-OX | 0.24 | 4.32 |
| Epoxy + 4% GN-OX | 0.37 | 5.60 |
| Epoxy + 0.1% Si-GN | 0.28 | 4.31 |
| Epoxy + 0.5% Si-GN | 0.28 | 4.41 |
| Epoxy + 1% Si-GN | 0.29 | 4.40 |
| Epoxy + 2% Si-GN | 0.28 | 4.43 |
| Epoxy + 4% Si-GN | 0.37 | 5.79 |
| Epoxy + 0.1% Si-GN-OX | 0.28 | 4.28 |
| Epoxy + 0.5% Si-GN-OX | 0.28 | 4.52 |
| Epoxy + 1% Si-GN-OX | 0.29 | 4.61 |
| Epoxy + 2% Si-GN-OX | 0.28 | 4.80 |
| Epoxy + 4% Si-GN-OX | 0.31 | 5.03 |

As shown in Table 2, the base Epoxy L20 exhibits a strength of 0.22 GPa and Young's modulus of 4.04 GPa. Upon doping the composite with GN-based nanomaterials, e.g., GN, GN-OX, Si-GN, and Si-GN-OX, both strength and Young's modulus increased in all composites in all doping percentages above 1% by total weight of epoxy. The largest enhancements in both strength and Young's modulus were observed at 4% doping of GN, GN-OX, Si-GN, and Si-GN-OX compared to the base, undoped epoxy resin. The highest strength value was observed at 4% doping of silane-coated GN (Epoxy+4% Si-GN) and oxidized GN (Epoxy+4% GN-OX) with over 68% increase while the highest Young's modulus was observed at 4% doping of silane-coated GN (Epoxy+4% Si-GN) with over 43% increase.

### Example 3: Thermal Characteristics of Carbon-Based Nanomaterial Resin Composite

Thermal expansion of the modified resins was investigated in the temperature range from 25° C. to 200° C. in the heating and cooling cycles performed in the nitrogen atmosphere. Heating was performed at the rate 2° C. per min. Based on the results thermal properties, e.g., glass transition temperature (T_{g}), coefficient of thermal expansion in 25-80° C. (Alpha I), and coefficient of thermal expansion in 125-180° C. (Alpha II), were determined.

TABLE 3
Thermal expansion properties of CNT-based resin composites.

| | Heating Cycle | | | Cooling Cycle | | |
|---|---|---|---|---|---|---|
| | | Alpha I | Alpha II | | Alpha I | Alpha II |
| | Tg | 25-80° C. | 125-180° C. | Tg | 25-80° C. | 125-180° C. |
| Material | (° C.) | (μm/m° C.) | (μm/m° C.) | (° C.) | (μm/m° C.) | (μm/m° C.) |
| Epoxy L20 | 100.9 | 73.40 | 181.4 | 94.3 | 74.3 | 187.9 |
| Epoxy + 0.1% CNT | 102.3 | 71.6 | 189 | 93.8 | 78.5 | 191.6 |
| Epoxy + 0.5% CNT | 109.8 | 64.8 | 181.8 | 98 | 70.4 | 185.9 |
| Epoxy + 1% CNT | 114 | 67.5 | 176.1 | 101.5 | 69.3 | 182.8 |
| Epoxy + 2% CNT | 115.9 | 66.7 | 175.5 | 102.9 | 68 | 182.8 |
| Epoxy + 4% CNT | 111 | 62.3 | 174.8 | 103.1 | 66.4 | 178.7 |
| Epoxy + 0.1% CNT-OX | 108.9 | 71 | 185.5 | 98 | 73.7 | 190.9 |
| Epoxy + 0.5% CNT-OX | 112.6 | 71.2 | 180.3 | 101.8 | 69.7 | 186 |
| Epoxy + 1% CNT-OX | 110.2 | 67.9 | 182.3 | 98.9 | 72.52 | 190.8 |
| Epoxy + 2% CNT-OX | 107.4 | 70.1 | 178.5 | 99 | 71.9 | 185.9 |
| Epoxy + 4% CNT-OX | 99.9 | 69.5 | 178.7 | 96.4 | 70.9 | 184.5 |
| Epoxy + 0.1% Si-CNT | 111.9 | 67.1 | 179.4 | 101.5 | 69.3 | 180 |
| Epoxy + 0.5% Si-CNT | 114.2 | 65.9 | 178.9 | 103.8 | 68.2 | 178.4 |
| Epoxy + 1% Si-CNT | 115.3 | 65.3 | 174.5 | 105.8 | 67.1 | 177.3 |
| Epoxy + 2% Si-CNT | 115.4 | 62.3 | 173 | 105.9 | 66.4 | 175.9 |
| Epoxy + 4% Si-CNT | 109 | 64.8 | 176.4 | 102.1 | 66.1 | 178.4 |
| Epoxy + 0.1% Si-CNT-OX | 113.6 | 64 | 177.7 | 103 | 68.4 | 178.2 |
| Epoxy + 0.5% Si-CNT-OX | 112.3 | 61.3 | 190.9 | 99.2 | 72.9 | 190 |
| Epoxy + 1% Si-CNT-OX | 113.4 | 63.9 | 184.6 | 101.2 | 70.5 | 185.5 |
| Epoxy + 2% Si-CNT-OX | 112.3 | 69.6 | 187.4 | 103.5 | 70.3 | 191 |
| Epoxy + 4% Si-CNT-OX | 110.7 | 65.4 | 185.3 | 102.5 | 69.1 | 187.2 |

TABLE 4
Thermal expansion properties of GN-based resin composites.

| | Heating Cycle | | | Cooling Cycle | | |
|---|---|---|---|---|---|---|
| | | Alpha I | Alpha II | | Alpha I | Alpha II |
| | Tg | 25-80° C. | 125-180° C. | Tg | 25-80° C. | 125-180° C. |
| Material | (° C.) | (μm/m° C.) | (μm/m° C.) | (° C.) | (μm/m° C.) | (μm/m° C.) |
| Epoxy L20 | 100.9 | 73.40 | 181.4 | 94.3 | 74.3 | 187.9 |
| Epoxy + 0.1% GN | 105.2 | 69.9 | 188 | 97.9 | 76 | 192 |
| Epoxy + 0.5% GN | 101.3 | 72.4 | 185.9 | 95.6 | 77.8 | 188.9 |
| Epoxy + 1% GN | 98.2 | 72.8 | 184.9 | 96.2 | 75.9 | 188.2 |
| Epoxy + 2% GN | 105.8 | 68.2 | 183.4 | 98 | 74.3 | 187.9 |
| Epoxy + 4% GN | 112.2 | 65.7 | 171.8 | 104.1 | 66 | 178.3 |
| Epoxy + 0.1% GN-OX | 98.5 | 73 | 188.6 | 96 | 77 | 189.7 |
| Epoxy + 0.5% GN-OX | 109.7 | 66.3 | 184 | 103 | 69.9 | 184.1 |
| Epoxy + 1% GN-OX | 105.8 | 70.2 | 174.9 | 100.3 | 70.5 | 184.1 |
| Epoxy + 2% GN-OX | 109 | 64.4 | 178.2 | 104.2 | 68.2 | 188 |
| Epoxy + 4% GN-OX | 115 | 68.9 | 182.7 | 105.8 | 69 | 190.2 |
| Epoxy + 0.1% Si-GN | 110.9 | 69.3 | 188.7 | 102.2 | 70.1 | 188 |
| Epoxy + 0.5% Si-GN | 111.1 | 69.2 | 182.6 | 103 | 69.7 | 184.4 |
| Epoxy + 1% Si-GN | 111.1 | 62.6 | 178.5 | 103.1 | 68.1 | 180 |
| Epoxy + 2% Si-GN | 113 | 66.5 | 178.2 | 105.1 | 67.8 | 179.4 |
| Epoxy + 4% Si-GN | 113.2 | 65.1 | 180 | 105.3 | 66.4 | 180.9 |
| Epoxy + 0.1% Si-GN-OX | 107.1 | 65.4 | 184.4 | 100.2 | 71.7 | 187.9 |
| Epoxy + 0.5% Si-GN-OX | 112.7 | 67.9 | 181.1 | 103.3 | 69.5 | 181 |
| Epoxy + 1% Si-GN-OX | 115 | 67.1 | 177.4 | 104.6 | 68.7 | 180.7 |
| Epoxy + 2% Si-GN-OX | 111.8 | 64.5 | 176 | 104.1 | 68.4 | 178.1 |
| Epoxy + 4% Si-GN-OX | 110.7 | 65.9 | 173.1 | 104.6 | 66.3 | 173.3 |

As shown in Tables 3 and 4, the base Epoxy L20 exhibits glass transition temperature (Tg) of 100.9° C., Alpha I of 73.40 μm/m° C., and Alpha II of 181.4 μm/m° C. during the heating cycle and Tg of 94.3° C., Alpha I of 74.3 μm/m° C., and Alpha II of 187.9 μm/m° C. Upon introducing CNT and GN dopants to the base Epoxy, the Tg generally increases with the highest Tg value of about 115° C. during the heating cycle and about 105° C. during the cooling cycle. Additionally, the data shows the thermal expansion for the CNT and GN-modified resins is generally lower compared to the base epoxy resin indicating greater thermal stability of the carbon-based nanomaterial resin composite.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances which fall within the scope of the appended claims.

The features from different embodiments disclosed in this document may be freely combined. For example, one or more features from a method embodiment may be combined with any of the product embodiments. Similarly, features from a product embodiment may be combined with any of the method embodiments disclosed in this document.

Without excluding further possible embodiments, certain example embodiments are summarized in the following example clauses:

Clause 1: A carbon-based nanomaterial resin composite comprising a host resin doped with a carbon-based nanomaterial filler, wherein the filler comprises: a carbon-based nanomaterial; and magnetic nanoparticles attached to the carbon-based nanomaterials.

Clause 2: The carbon-based nanomaterial resin composite of clause 1, wherein the host resin comprises a resin selected from the group consisting of epoxy-based resin, polyester resin, vinyl ester resin, polyurethane resin, phenolic resin, polyimide resin, silicone resin, and acrylic resin, or a combination thereof.

Clause 3: The carbon-based nanomaterial resin composite of clause 1 or clause 2, wherein the carbon-based nanomaterial comprises single-walled carbon nanotubes, multi-walled carbon nanotubes, graphene, or a combination thereof.

Clause 4: The carbon-based nanomaterial resin composite of clause 3, wherein the magnetic nanoparticles are attached to the single-walled carbon nanotubes and multi-walled carbon nanotubes at nanotube ends and/or confined within inner space of the single-walled carbon nanotubes or multi-walled carbon nanotubes.

Clause 5: The carbon-based nanomaterial resin composite of any of the preceding clauses, wherein the carbon-based nanomaterial is oxidized.

Clause 6: The carbon-based nanomaterial resin composite of any of the preceding clauses, wherein the carbon-based nanomaterial comprises one or more substituents selected from the group consisting of silane, hydroxyl, carboxylic acid, amine, and any combination thereof.

Clause 7: The carbon-based nanomaterial resin composite of any of the preceding clauses, wherein the magnetic nanoparticles comprise a metal, an alloy, a metal oxide, or a combination thereof.

Clause 8: The carbon-based nanomaterial resin composite of clause 7, wherein the magnetic nanoparticles comprise nickel, iron, cobalt, alloys thereof, oxides thereof, or a combination thereof.

Clause 9: The carbon-based nanomaterial resin composite of clause 7 or clause 8, wherein diameter of the magnetic nanoparticles is about 3 nm to about 100 nm.

Clause 10: The carbon-based nanomaterial resin composite of any of the preceding clauses, which has a tensile strength of more than 0.35 GPa and a Young's Modulus of more than 5.50 GPa.

Clause 11: The carbon-based nanomaterial resin composite of any of the preceding clauses, wherein the carbon-based nanomaterial filler comprises between about 0.1 wt. % and about 5 wt. % of the total weight of the host resin.

Clause 12: The carbon-based nanomaterial resin composite of any of the preceding clauses, wherein the magnetic nanoparticles and carbon-based nanomaterials are mixed in a mass ratio of about 1:100 and about 4:100.

Clause 13: An article of manufacture comprising the carbon-based nanomaterial resin composite of any of the preceding clauses.

Clause 14: The article of clause 13, further comprising an automotive part, electromagnetic interference and radiofrequency shielding, antistatic coating, flexible and printable electronics, batteries, supercapacitors, heat sinks, and water filters.

Clause 15: A method of synthesizing a carbon-based nanomaterial resin composite of any one of clauses 1-13, the method comprising: (a) growing carbon-based nanomaterials, wherein magnetic nanoparticles are attached to the carbon-based nanomaterials; (b) optionally oxidizing surface of the carbon-based nanomaterials; (c) optionally coating surface of the carbon-based nanomaterials; and (d) introducing carbon-based nanomaterials of step (a), (b), or (c) to a host resin.

Clause 16: The method of clause 15, further comprising in step (c) coating the carbon-based nanomaterials with one or more substituents selected from the group consisting of silane, hydroxyl, carboxylic acid, amine, and any combination thereof.

Clause 17: The method of clause 15 or 16, further comprising before step (d), optionally attaching additional magnetic nanoparticles on the carbon-based nanomaterials of steps (a), (b), or (c).

Clause 18: The method of any of clauses 15-17, wherein step (d) comprises introducing about 0.1 wt. % and about 5 wt. % of carbon-based nanomaterials in steps (a), (b), or (c) to the host resin, based on the total weight of the host resin.

Clause 19: The method of any of clauses 15-18, further comprising uniformly dispersing the carbon-based nanomaterials in the host resin, the method comprising: placing the carbon-based nanomaterial resin composite in an alternating magnetic field, wherein the alternating magnetic field results in heating of the magnetic nanoparticles and uniform dispersion of the carbon-based nanomaterials in the host resin.

Clause 20: The method of any of clauses 15-19, further comprising aligning the carbon-based nanomaterials in the host resin, the method comprising: switching the alternating magnetic field to a constant magnetic field, wherein the constant magnetic field results in an alignment of the carbon-based nanomaterials along direction of the constant magnetic field.

1. A carbon-based nanomaterial resin composite comprising a host resin doped with a carbon-based nanomaterial filler, wherein the filler comprises:
a carbon-based nanomaterial; and
magnetic nanoparticles attached to the carbon-based nanomaterials.

2. The carbon-based nanomaterial resin composite of claim 1, wherein the host resin comprises a resin selected from the group consisting of epoxy-based resin, polyester resin, vinyl ester resin, polyurethane resin, phenolic resin, polyimide resin, silicone resin, and acrylic resin, or a combination thereof.

3. The carbon-based nanomaterial resin composite of claim 1, wherein the carbon-based nanomaterial comprises single-walled carbon nanotubes, multi-walled carbon nanotubes, graphene, or a combination thereof.

4. The carbon-based nanomaterial resin composite of claim 3, wherein the magnetic nanoparticles are attached to the single-walled carbon nanotubes and multi-walled carbon nanotubes at nanotube ends and/or confined within inner space of the single-walled carbon nanotubes or multi-walled carbon nanotubes.

5. The carbon-based nanomaterial resin composite of claim 1, wherein the carbon-based nanomaterial is oxidized.

6. The carbon-based nanomaterial resin composite of claim 1, wherein the carbon-based nanomaterial comprises one or more substituents selected from the group consisting of silane, hydroxyl, carboxylic acid, amine, and any combination thereof.

7. The carbon-based nanomaterial resin composite of claim 1, wherein the magnetic nanoparticles comprise a metal, an alloy, a metal oxide, or a combination thereof.

8. The carbon-based nanomaterial resin composite of claim 7, wherein the magnetic nanoparticles comprise nickel, iron, cobalt, alloys thereof, oxides thereof, or a combination thereof.

9. The carbon-based nanomaterial resin composite of claim 7, wherein diameter of the magnetic nanoparticles is about 3 nm to about 100 nm.

10. The carbon-based nanomaterial resin composite of claim 1, which has a tensile strength of more than 0.35 GPa and a Young's Modulus of more than 5.50 GPa.

11. The carbon-based nanomaterial resin composite of claim 1, wherein the carbon-based nanomaterial filler comprises between about 0.1 wt. % and about 5 wt. % of the total weight of the host resin.

12. The carbon-based nanomaterial resin composite of claim 1, wherein the magnetic nanoparticles and carbon-based nanomaterials are mixed in a mass ratio of about 1:100 and about 4:100.

13. An article of manufacture comprising the carbon-based nanomaterial resin composite of claim 1.

14. The article of claim 13, further comprising an automotive part, electromagnetic interference and radiofrequency shielding, antistatic coating, flexible and printable electronics, batteries, supercapacitors, heat sinks, and water filters.

15. A method of synthesizing a carbon-based nanomaterial resin composite of claim 1, the method comprising:
(a) growing carbon-based nanomaterials, wherein magnetic nanoparticles are attached to the carbon-based nanomaterials;
(b) optionally oxidizing surface of the carbon-based nanomaterials;
(c) optionally coating surface of the carbon-based nanomaterials; and
(d) introducing carbon-based nanomaterials of step (a), (b), or (c) to a host resin.

16. The method of claim 15, further comprising in step (c) coating the carbon-based nanomaterials with one or more substituents selected from the group consisting of silane, hydroxyl, carboxylic acid, amine, and any combination thereof.

17. The method of claim 15, further comprising before step (d), optionally attaching additional magnetic nanoparticles on the carbon-based nanomaterials of steps (a), (b), or (c).

18. The method of claim 15, wherein step (d) comprises introducing about 0.1 wt. % and about 5 wt. % of carbon-based nanomaterials in steps (a), (b), or (c) to the host resin, based on the total weight of the host resin.

19. The method of claim 15, further comprising uniformly dispersing the carbon-based nanomaterials in the host resin, the method comprising: placing the carbon-based nanomaterial resin composite in an alternating magnetic field,
wherein the alternating magnetic field results in heating of the magnetic nanoparticles and uniform dispersion of the carbon-based nanomaterials in the host resin.

20. The method of claim 15, further comprising aligning the carbon-based nanomaterials in the host resin, the method comprising: switching the alternating magnetic field to a constant magnetic field,
wherein the constant magnetic field results in an alignment of the carbon-based nanomaterials along direction of the constant magnetic field.
